(19) United States
(12) Patent Application Publication
(10) Pub. No.: US 2010/0325536 A1
(43) Pub. Date: Dec. 23, 2010

(54) APPLICATION ORCHESTRATOR

(75) Inventors: Fanguang Kong, Beijing (CN); Ying Xu, Beijing (CN); Shu Chen, Beijing (CN); Yong Rui, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/487,659

(22) Filed: Jun. 19, 2009

(51) Int. Cl. G06F 17/00

(52) U.S. Cl. 715/255

(57) ABSTRACT

A method for orchestrating various applications is described herein. A request to store a context information regarding a document may be received. An application in which the document is modified may be determined. The context information may be requested from the application. The context information may be stored. A request to recall the context information may be received. The context information may be displayed on a computer screen.

### BACKGROUND

In the workplace, many simple tasks can be performed using a computer application. For example, a user can write a business letter using a word processor, or send emails using an email application.

However, with complex tasks that involve the use of multiple computer applications, organizing data to complete the complex tasks can be complicated. Not only does the user need to recall the location of all the files used in the different applications, the user may need reminders about the significance of certain data. Additionally, the presence of multiple users may complicate completing the task.

### SUMMARY

Described herein are implementations of various technologies for orchestrating numerous computer applications. Data from within a document (or the document itself) may be linked such that other applications may access it, along with information that puts the linked data into context for the user. Examples of the context information include an application identifier, user-selected excerpts, a uniform resource identifier (URI), etc.

The user may link the data across the numerous computer applications using either an explicit or implicit interface. The explicit interface allows the user to create links and view the context information alongside notes about the linked data. The explicit interface may also provide a centralized location for the user to reference multiple links to data and associated context information. The implicit interface allows the user to create links and view context information within the applications themselves.

The claimed subject matter is not limited to implementations that solve any or all of the noted disadvantages. Further, the summary section is provided to introduce a selection of concepts in a simplified form that are further described below in the detailed description section. The summary section is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of a computing system in which the various technologies described herein may be incorporated and practiced.

FIG. 2 illustrates a context recall model in accordance with various implementations of the technologies described herein.

FIG. 3 illustrates a representation of a screen shot of an explicit orchestrator in accordance with implementations of various techniques described herein.

FIG. 4 illustrates a flow chart of a method for explicitly storing an entry in the context recall model in accordance with implementations described herein.

FIG. 5 illustrates a flow chart of a method for implicitly storing an entry in the context recall model in accordance with implementations described herein.

FIG. 6 illustrates a flow chart of a method for recalling context information in accordance with implementations described herein.

### DETAILED DESCRIPTION

In general, one or more implementations of various technologies described herein are directed towards registering media for configurable advertising. The various implementations will be described in more detail in the following paragraphs.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer-readable storage media including memory storage devices.

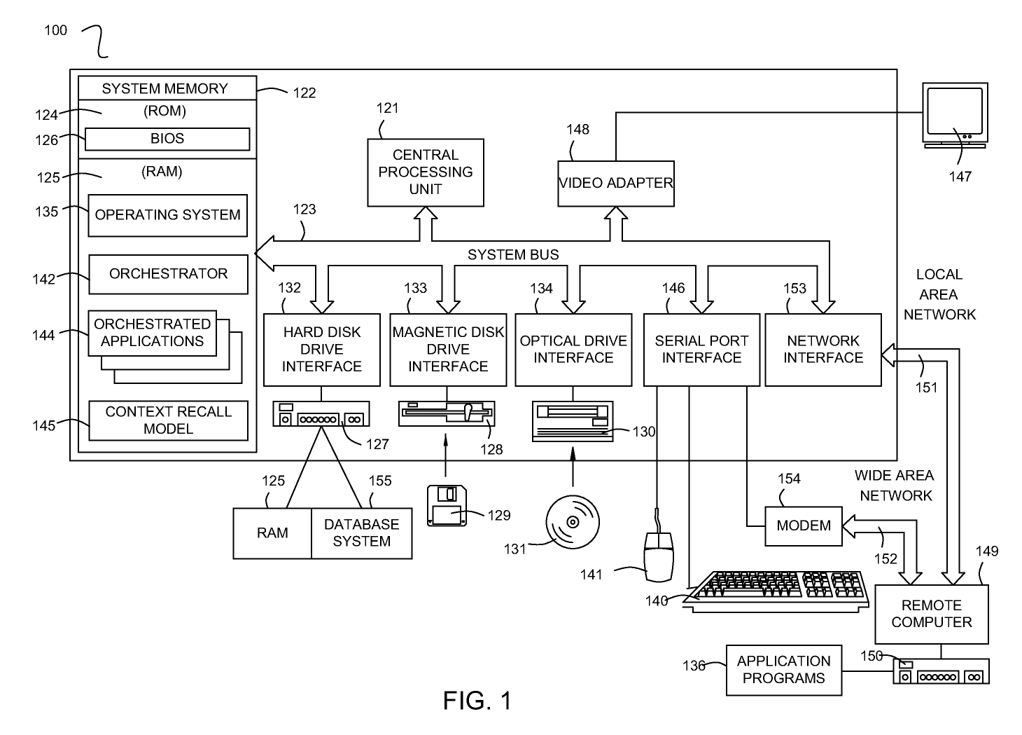

FIG. 1 illustrates a schematic diagram of a computing system 100 in which the various technologies described herein may be incorporated and practiced. The computing system 100 may include a central processing unit (CPU) 121, a system memory 122 and a system bus 123 that couples various system components including the system memory 122 to the CPU 121. Although only one CPU is illustrated in FIG. 1, it should be understood that in some implementations the computing system 100 may include more than one CPU.

The system bus 123 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 122 may include a read only memory (ROM) 124 and a random access memory (RAM) 125. A basic input/output system (BIOS) 126, containing the basic routines that help transfer information between elements within the computing system 100, such as during start-up, may be stored in the ROM 124.

The computing system 100 may further include a hard disk drive 127 for reading from and writing to a hard disk, a magnetic disk drive 128 for reading from and writing to a removable magnetic disk 129, and an optical disk drive 130 for reading from and writing to a removable optical disk 131, such as a CD ROM or other optical media. The hard disk drive 127, the magnetic disk drive 128, and the optical disk drive 130 may be connected to the system bus 123 by a hard disk drive interface 132, a magnetic disk drive interface 133, and an optical drive interface 134, respectively. The drives and their associated computer-readable media may provide nonvolatile storage of computer-readable instructions, data structures, program modules and other data for the computing system 100.

Although the computing system 100 is described herein as having a hard disk, a removable magnetic disk 129 and a removable optical disk 131, it should be appreciated by those skilled in the art that the computing system 100 may also include other types of computer-readable media that may be accessed by a computer. For example, such computer-readable media may include computer-readable storage media and communication media.

Computer-readable storage media may include volatile and non-volatile and removable and non-removable media implemented in any method or technology for storage of information, such as computer-readable instructions, data structures, program modules or other data. Computer-readable storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100.

Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of the any of the above may also be included within the scope of computer readable media.

A number of modules may be stored on the hard disk, magnetic disk 129, optical disk 131, ROM 124 or RAM 125, including an operating system 135, an orchestrator 142, one or more orchestrated applications 144, a context recall model 145, and a database system 155. The operating system 135 may be any suitable operating system that may control the operation of a networked personal or server computer, such as Windows® Vista, Mac OS® X, Unix-variants (e.g., Linux® and BSD®), and the like.

The orchestrator 142 may enable a user to link data across multiple orchestrated applications 144. In one implementation, data may be linked across multiple orchestrated applications 144 by transferring the data from one orchestrated application to another orchestrated application. In another implementation, the data in one orchestrated application may be linked across multiple orchestrated applications 144 by providing access for those orchestrated applications 144.

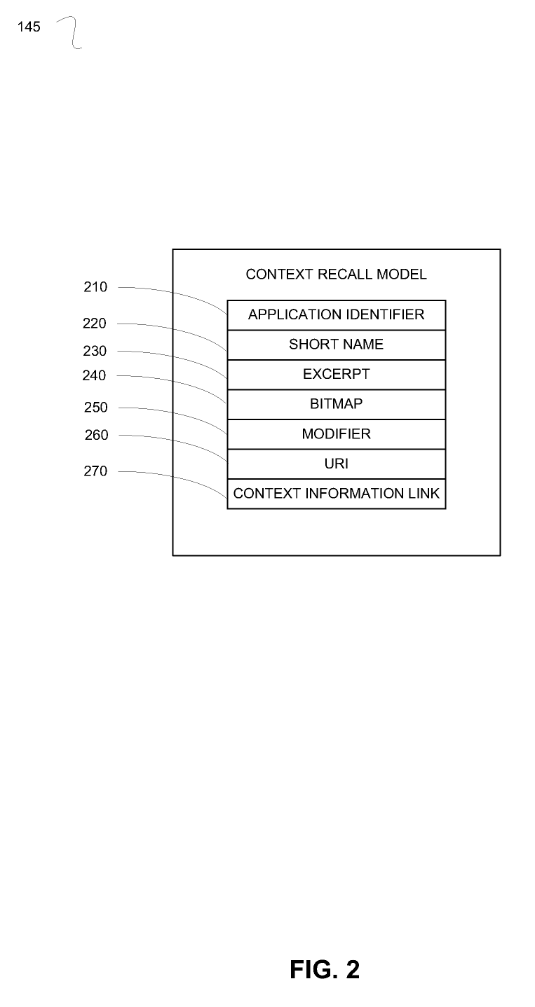

The orchestrator 142 may also provide an interface that displays context information about linked data on a monitor 147. The context information about the linked data may be stored in the context recall model 145. The context information is described in greater detail with reference to FIG. 2.

The orchestrator 142 may either be explicit or implicit. The explicit orchestrator uses an interface that is distinct from the interface for the orchestrated application 144. The implicit orchestrator uses an interface that is integrated within the interface of the orchestrated application 144.

The orchestrated applications 144 may include typical desktop software, such as word processing, spreadsheet and email applications. The orchestrated applications 144 may also include software directed to specific tasks, such as accounting applications, or any other applications that may be used to perform complex tasks.

A user may enter commands and information into the computing system 100 through input devices such as a keyboard 140 and pointing device 141. Other input devices may include a microphone, joystick, game pad, satellite dish, scanner, or the like. These and other input devices may be connected to the CPU 121 through a serial port interface 146 coupled to system bus 123, but may be connected by other interfaces, such as a parallel port, game port or a universal serial bus (USB). The monitor 147 or other type of display device may also be connected to system bus 123 via an interface, such as a video adapter 148. In addition to the monitor 147, the computing system 100 may further include other peripheral output devices, such as speakers and printers.

Further, the computing system 100 may operate in a networked environment using logical connections to one or more remote computers, such as a remote computer 149. The remote computer 149 may be another personal computer, a server, a router, a network PC, a peer device or other common network node. Although the remote computer 149 is illustrated as having only a memory storage device 150, the remote computer 149 may include many or all of the elements described above relative to the computing system 100. The logical connections may be any connection that is commonplace in offices, enterprise-wide computer networks, intranets, and the Internet, such as local area network (LAN) 151 and a wide area network (WAN) 152.

When using a LAN networking environment, the computing system 100 may be connected to the LAN 151 through a network interface or adapter 153. When used in a WAN networking environment, the computing system 100 may include a modem 154, wireless router or other means for establishing communication over a WAN 152, such as the Internet. The modem 154, which may be internal or external, may be connected to the system bus 123 via the serial port interface 146. In a networked environment, program modules depicted relative to the computing system 100, or portions thereof, may be stored in a remote memory storage device 150. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device.

FIG. 2 illustrates the context recall model 145 in accordance with various implementations of the technologies described herein. The context recall model 145 may include context information about data that the user links across the orchestrated applications 144.

In one implementation, the linked data may be a document that is modified in one of the orchestrated applications 144. The term, document, is used generically to reference any file that a computer application may access or modify. Examples of documents include, but are not limited to: word processing documents, spreadsheets, images, and the like. In another implementation, the linked data may be data within the document.

As shown, the context recall model 145 may include an application identifier 210, a short name 220, an excerpt 230, a bitmap 240, a modifier 250, a uniform resource identifier (URI) 260, and a context information link 270.

The application identifier 210 may specify the orchestrated application 144 to which the linked data is linked. For example, the user may create proposed expenses in a spreadsheet application. In response to a user request, the orchestrator 142 may link those expenses to another orchestrated application for approving the proposed expenses. In such a scenario, the application identifier 210 may identify the spreadsheet application used to create the proposed expenses. In one implementation, the application identifier 210 may be an icon image that identifies the orchestrated application 144.

The short name 220 may include a title or other short descriptor for the linked data. In one implementation, the short name 220 may be a title of the document that contains the linked data. In the above example, the short name 220 may be, “Proposed Expenses.xls.”

The excerpt 230 may be a user selection from the document containing the linked data. For example, from the proposed expenses spreadsheet, the user may select cells that contain an item labeled, “Total Expenses,” with a total expense amount. The total expenses data in those cells may be stored as the excerpt 230. The bitmap 240 may be a thumbnail image that represents the linked data.

The modifier 250 may specify information about a most recent update to the linked data. For example, the modifier 250 may specify the user that last updated the linked data. Additionally, the modifier 250 may specify a timestamp of the last update. The URI 260 may identify a location of the linked data, such as a network or local disk directory location.

In one implementation, the context recall model 145 may include the context information link 270. In scenarios that include a number of orchestrated applications 144, the context information link 270 may be one entry in a linked list of context information. A linked list may be a data structure that consists of a sequence of data records/rows such that, in each record/row, there is a field that contains a reference (i.e., a link) to the next record/row in the sequence.

The linked list of context information may include one or more previous modifiers of the linked data, e.g., the document. Expanding upon the spreadsheet scenario described above, the approval application may send approved expenses to a financing application that disburses funds. In such a scenario, there may be 3 records stored in the context recall model 145. The record for the financing application may include a context information link to the record for the approval application. Similarly, the record for the approval application may include a context information link to the record for the spreadsheet application. The relevant elements of the context recall model for this example are illustrated in Table 1:

TABLE 1

| APPLICATION | | | CONTEXT |
|---|---|---|---|
| IDENTIFIER | MODIFIER | URI | INFORMATION LINK |
| SPREADSHEET | EMPLOYEE | \\NETWORK\EXP.XLS | |
| APPROVAL | MANAGER | \\NETWORK\APP.DOC | EXP.XLS |
| DISBURSEMENT | FINANCE | \\NETWORK\DISB.REC | APP.DOC |

As shown in Table 1, the DISBURSEMENT data is linked back to the APPROVAL data by context information link APP.DOC, which represents an identifier for the linked APPROVAL data. Similarly, the APPROVAL data is linked back to the SPREADSHEET data by context information link EXP.XLS, which represents an identifier for the linked SPREADSHEET data. While in this example the names of the respective documents are used as the context information links, other identifiers may be used in implementations of the various techniques described herein.

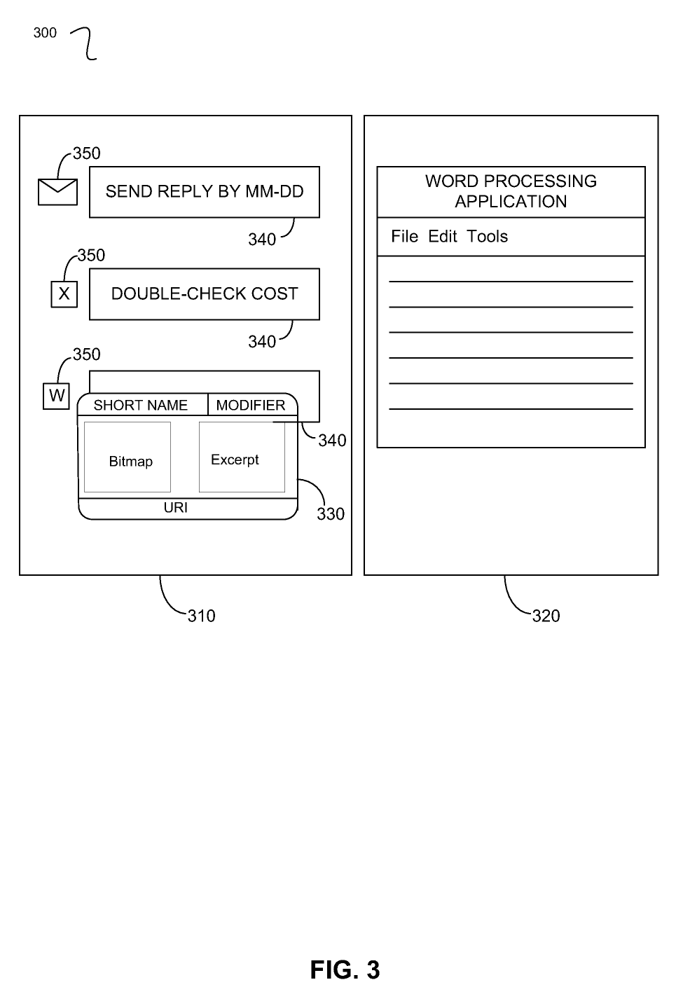

FIG. 3 illustrates a representation of a screen shot 300 of an explicit orchestrator in accordance with implementations of various techniques described herein. The screen shot 300 may include an orchestrator user interface (UI) 310 and an orchestrated application UI 320. As shown, the orchestrated application UI 320 is for a word processing application.

The orchestrator UI 310 may include a field for a note 340 and a context application widget 350 for each item of data that is linked to the orchestrated application 144. The orchestrator UI 310 may also include a context recall display 330.

The context application widget 350 may be an icon or other symbol that represents the orchestrated application 144 for an item of linked data. For example, the context application widget 350 illustrated as an envelope may represent an email application from which an email or other data may be linked to the word processing application shown in the screen shot 300. For example, the field for the note 340 next to the email widget, “SEND REPLY BY MM—DD” may be a note that the user entered while viewing an email in the email application.

Similarly, the context application widget 350 with the “X” may represent a spreadsheet. The note field for the spreadsheet, “DOUBLE-CHECK COST” may be a note the user typed while viewing the spreadsheet.

The context application widget 350 may also be configured to display information from the context recall model 145 in response to a user selection. In one implementation, the orchestrator 142 may display the context recall display 330 in response to a mouse-over operation on one of the context application widgets 350.

As shown, the context recall display 330 may include the short name 220, excerpt 230, bitmap 240, modifier 250, and URI 260. In one implementation, the URI in the context recall display 330 may be configured as a hyperlink to the linked data. For example, the URI displayed for the email widget may be configured to open the email that the user was reading when typing the “SEND REPLY BY MM—DD” note.

It should be noted that the context recall display 330 may vary according to user preferences. For example, the user may specify that only some of the information shown be displayed. In one implementation, another format for the context recall display 330 may be specified by the user. In another implementation, instead of the URI, the user may specify that the note 340 be configured as a hyperlink to the linked data.

In a scenario where the linked data has a context information link 270, the context recall display 330 for each link in the linked list may be displayed in a step-by-step fashion. In a first step, the context recall display 330 for the first link in the list may be displayed in response to a mouse-over operation on the context recall display 330. In subsequent steps, context recall displays for subsequent links in the linked list may be displayed in response to subsequent mouse-over operations on the context recall displays 330 for each of the links. In this manner, one or more previous modifiers of the document may be displayed.

As shown, the orchestrator UI 310 may be displayed alongside the orchestrated application UI 320. In the implementation with the implicit orchestrator, the elements of the orchestrator UI 310 may instead be displayed within the orchestrated application UI 320.

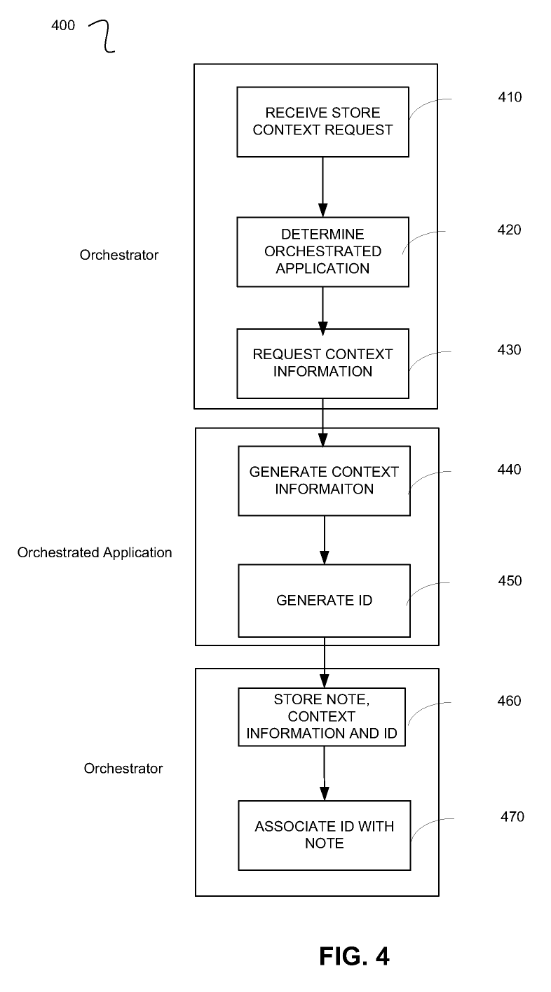

FIG. 4 illustrates a flow chart of a method 400 for explicitly storing an entry in the context recall model 145 in accordance with implementations described herein. The orchestrator 142 and the orchestrating applications 144 may perform method 400. It should be understood that while the flow chart indicates a particular order of execution, in some implementations, certain steps of method 400 may be executed in a different order.

The explicit storing takes place in response to a store context request entered via the explicit orchestrator UI 310 previously described with reference to FIG. 3. As such, at step 410, a store context request may be received. In one implementation, the store context request may be entered using a mouse-over operation on a note-taking region of the computer screen, i.e., the orchestrator UI 310. The store context request may include the note 340 entered by the user.

The store context request may be a request from the user to capture the context of the data that is to be linked. The data that is to be linked may be the document itself or an excerpt of data within that document.

The orchestrator 142 may work together with several orchestrated applications 144 at one time. As such, at step 420, the orchestrator 142 may determine the orchestrated application 144 from which the data is to be linked.

At step 430, the context information for the document may be requested. As stated previously, the context information may include one or more of the fields of the context recall model 145, described with reference to FIG. 2.

In one implementation, the orchestrator 142 may request the context information from the orchestrated application 144. In another implementation, the orchestrator 142 may determine some context information, and request the remaining context information from the orchestrated application 144.

At step 440, the context information may be generated. In response to the request for context information from the orchestrator 142, the orchestrated application 144 may generate all the context information for the context recall model 145.

Two fields of the context recall model 145 that may be requested are the short name 220, and the excerpt 230. In one implementation, in response to the request for the context information, the orchestrated application 144 may generate a short name such as, the title of the document currently open in the orchestrated application 144. The orchestrated application 144 may also generate the excerpt 230 as any data that is currently selected, e.g., highlighted by the user, within the orchestrated application 144.

At step 450, an identifier (ID) may be generated. The ID may uniquely identify the context recall model entry being created. The ID allows for ready recall of the context information for the newly created context recall model entry.

At step 460, the orchestrator 142 may store the context information and the ID. The context information and ID may be stored as an entry in the context recall model 145. In one implementation, the ID may be stored separately from the context recall model 145. As stated previously, the store context request may include the note 340, which may also be stored. At step 470, the note 340 may be associated with the ID generated at step 450.

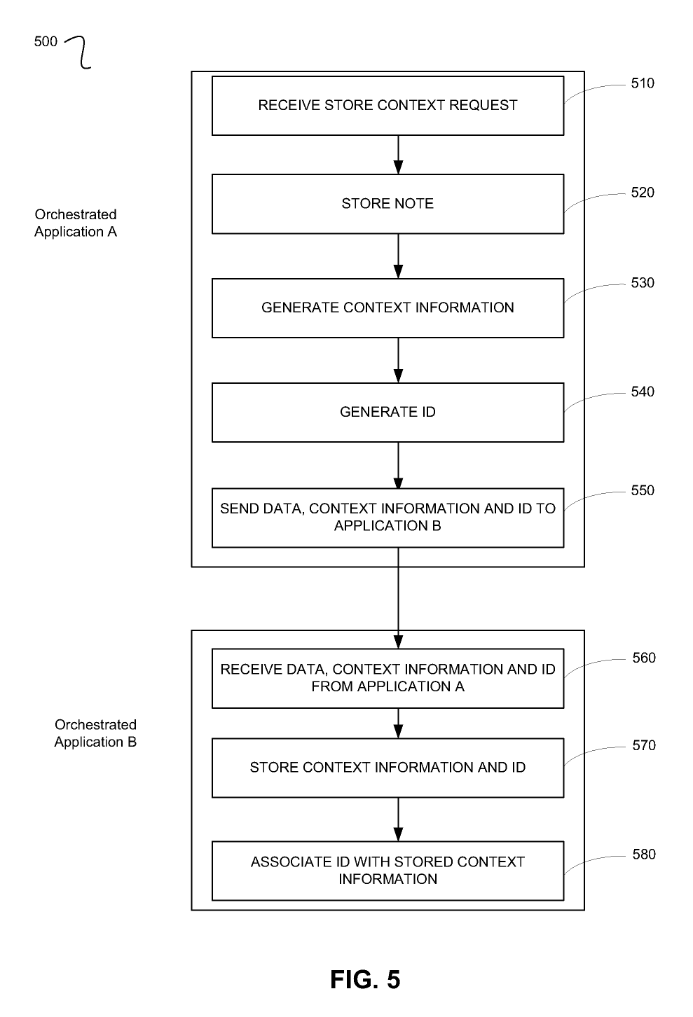

FIG. 5 illustrates a flow chart of a method 500 for implicitly storing an entry in the context recall model 145 in accordance with implementations described herein. It should be understood that while the flow chart indicates a particular order of execution, in some implementations, certain steps of method 500 may be executed in a different order.

The implicit store may be requested from within a first orchestrated application, for reference by a second orchestrated application. The first and second orchestrated applications (labeled Orchestrated Application A and Orchestrated Application B on FIG. 5) may perform method 500.

In one implementation, the Orchestrated Application B may reference the document modified by Orchestrated Application A. For example, in the expense scenario described above, the Orchestrated Application A may be the spreadsheet application for creating the proposed expenses. The Orchestrated Application B may be the approval application that references the proposed expenses.

At step 510, the store context request may be received by Orchestrated Application A. In one implementation, the store context request may be entered by the user via a push-button or menu selection in the orchestrated application 144. The store context request may specify the context information link 270. The context information link 270 may specify a document modified in another orchestrated application 144. For example, in the expense scenario described above, while modifying the proposed expenses in the spreadsheet application (Orchestrated Application A), the user may make a store context request. The store context request may specify a context information link 270 to an approval document in the approval application (Orchestrated Application B).

It should be noted that Orchestrated Application A and Orchestrated Application B may be the same application. For example, a Document A (not shown) modified in a word-processing application, may have a context information link to a Document B. As stated previously, the store context request may include a note. In the implementation where the store context request includes a note, at step 520, the note may be stored.

At step 530, Orchestrated Application A may generate the context information. This step is similar to step 440 described with reference to FIG. 4, except the context information is not generated in response to a request from the orchestrator 142.

At step 540, Orchestrated Application A may generate an identifier (ID). This step is similar to step 450 described with reference to FIG. 4. At step 550, the ID, context information, and note may be sent to Orchestrated Application B. At step 560, the ID, context information and note may be received at the subsequent orchestrated application, i.e., Orchestrated Application B.

For multiple users, e.g., the expense disbursement scenario, the linked data may be sent to Orchestrated Application B on the remote computer 149. For a single user, sending data to, and receiving data at, Orchestrated Application B may involve opening Orchestrated Application B.

For example, the user may be reading an email, and selects a menu option to store context information 145. The request to store the context information 145 may further specify a word processing document to which the user wishes to reference the context information 145 about the email. In this example, Orchestrated Application A is the email application and Orchestrated Application B is the word processing application. Sending and receiving the context information to the word processing document may involve opening the word processing application for the specified word processing document. Further, the widget 350 for the context information 145 regarding the email may be displayed within the specified word processing document.

At step 570, the context information and the ID may be stored. The context information and ID may be stored as an entry in the context recall model 145. In one implementation, the ID may be stored separately from the context recall model 145. In the implementation where the store context request includes the note 340, the note 340 may also be stored. In such an implementation, at step 580, the note 340 may be associated with the ID generated at step 540.

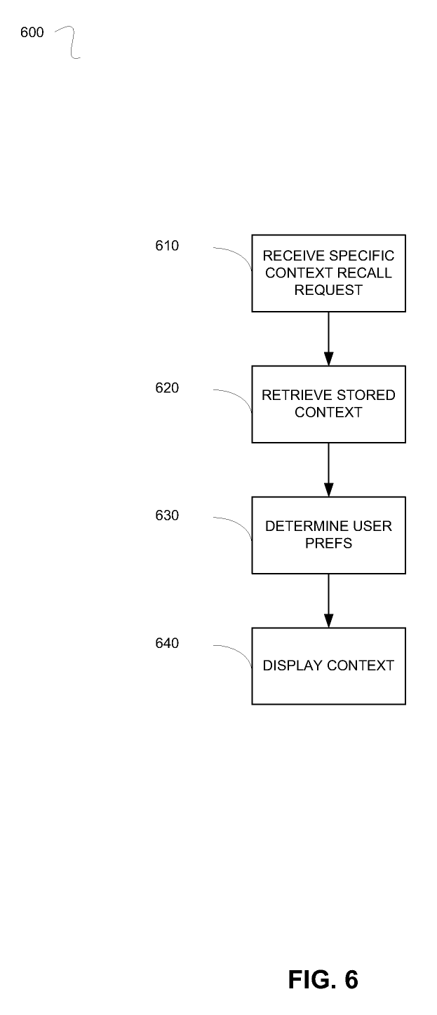

FIG. 6 illustrates a flow chart of a method 600 for recalling context information in accordance with implementations described herein. The orchestrator 142 may perform method 600. It should be understood that while the flow chart indicates a particular order of execution, in some implementations, certain steps of method 600 may be executed in a different order.

At step 610, a request for a specific context recall model entry may be received. The request may include the ID described with reference to FIGS. 4 and 5. As stated previously, the user may make a specific context recall request by hovering over the widget 350 for a particular note 340. In another implementation, the user may make the request using a right-mouse click, context menu selection, or like operation.

At step 620, the stored context information may be retrieved. The orchestrator 142 may retrieve the context information from the context recall model 145 using the ID supplied in the request.

At step 630, user preferences for displaying the context information may be determined. As stated previously, the user may specify preferences for what data from the context recall model 145 is displayed, and how it is displayed. At step 640, the context information may be displayed. In one implementation, the context information may be displayed within the context recall display 330.

One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for orchestrating various applications, comprising:
receiving a request to store a context information regarding a document;
determining an application in which the document is modified;
requesting the context information from the application;
storing the context information;
receiving a request to recall the context information; and
displaying the context information on a computer screen.

2. The method of claim 1, wherein the request to store the context information comprises:
the context information; and
a note that a user associates with the document.

3. The method of claim 2, further comprising displaying the note on the computer screen.

4. The method of claim 3, further comprising selecting the note displayed on the computer screen to open the document associated with the note.

5. The method of claim 1, wherein the context information further comprises:
a first modifier of the document, wherein the first modifier corresponds to a first user that modifies the document; and
a context information link to a second modifier of the document, wherein the second modifier corresponds to a second user that modifies the document.

6. The method of claim 5, wherein the context information further comprises a first timestamp when the first user modifies the document and a second timestamp when the second user modifies the document.

7. The method of claim 5, further comprising:
receiving a request to recall one or more previous modifiers of the document; and
displaying the one or more previous modifiers of the document.

8. The method of claim 7, wherein the request to recall the previous modifiers comprises a mouse-over operation on the displayed context information.

9. The method of claim 1, wherein the context information further comprises:
a uniform resource identifier (URI) of the document;
a title of the document;
an excerpt selected by a user from the document;
a thumbnail of the document;
an application identifier that identifies the application; or combinations thereof.

10. The method of claim 9, further comprising selecting the URI displayed on the computer screen to open the document associated with the URI.

11. The method of claim 9, wherein the request to recall the context information is received through a mouse-over operation on the application identifier.

12. The method of claim 9, wherein the application identifier comprises:
a text description; or an icon.

13. The method of claim 1, wherein the request to store the context information is received through a mouse-over operation on a note-taking region of the computer screen.

14. A method for orchestrating various applications, comprising:
receiving a request to store a context information regarding a document from a first application in which the document is modified;
generating the context information;
sending the context information to a second application that references the document;
receiving a request to recall the context information from the second application; and
displaying the context information in an interface of the second application on a computer screen.

15. The method of claim 14, further comprising displaying an application identifier of the first application in the interface of the second application.

16. The method of claim 15, wherein the context information is displayed in response to a selection of the displayed application identifier.

17. The method of claim 14, wherein the context information comprises:
a modifier of the document, wherein the modifier corresponds to a user that modifies the document in the first application;
a uniform resource identifier of the document;
a title of the document;
an excerpt selected by the user from the document;
a thumbnail of the document;
an application identifier that identifies the first application; or combinations thereof.

18. A user interface, comprising:
displaying an application identifier of an application that modifies a document;
receiving a selection of the application identifier; and
in response to receiving the selection, displaying a context information regarding the document, the context information comprising:
a modifier of the document, wherein the modifier corresponds to a user that modifies the document;
a title of the document;
a uniform resource identifier (URI) of the document;
an excerpt selected by the user from the document; and
a thumbnail of the document.

19. The user interface of claim 18, wherein the application identifier comprises:
a text description; or
an icon.

20. The user interface of claim 18, wherein the user interface is configured to open the document in response to a user selection of the displayed URI.
